(19) United States
(12) Patent Application Publication
(10) Pub. No.: US 2004/0158352 A1
(43) Pub. Date: Aug. 12, 2004

(54) Vending machine with a ' Walking Item-Selector', and methods of using it

(76) Inventor: Sang K. Sheem, Pleasanton, CA (US)

Correspondence Address: SANG K. SHEEM, 1790 PASEO DEL CAJON, PLEASANTON, CA, 94566, US

(21) Appl. No.: 10/364,185

(22) Filed: Feb. 11, 2003

(51) Int. Cl. G06F 17/00

(52) U.S. Cl. 700/243

(57) ABSTRACT

A novel concept is applied to the conventional vending machines in order to enhance the serviceability of the vending machines dramatically. The item-selector comprising a keypad or the like is made moveable so that it can ‘walk with customer’ as the customer walks up and down the vending machine in an effort to determine a right item for him. In this way, the customer does not have to walk between the item he wants to buy and the item-selector. Also, by making the moveable item-selector accompanied by a video camera, preferably with two-way communication capability, personal attention and service by an attendant located in a remote office becomes possible.

### NOTE

This invention disclosure is related to a patent application Ser. No. 10/299,502, titled, “Means of Item-Retrieving from a Display Hook, and Methods of Using it”, and another patent application Ser. No. 10/348,660, titled, “Method of Selling Controlled Items Through Vending Machines” filed on Jan. 21, 2003.

### TECHNICAL FIELD

This invention relates to self-service merchandise vending machines.

### BACKGROUND ART

All Laundromats are self-service operated. Gasoline stations have been switched to automated self-service systems during the last decades. Such a trend is desirable because it saves operating expenses and can offer 24-hour service. Similar changeover is desirable in the merchandise retail business. At the present time, only small-scale vending machines are located in the corners inside buildings. It would be desirable to establish a stand-alone self-service retail store in a form of a large-capacity vending machine.

As an example of a vending machine that handles 200 items is sold under the name ‘shop 2000’ (www.shop2000online.com).

In Europe one can find super-size vending machines (One report of spotting such a machine is found on http://www.kottke.org/02/11/021120huge_vending.html.)

When the size of a vending machine becomes large, one needs to walk a substantial distance between the merchandise item he wants to purchase and the selection keypad if the item happens to be located at the opposite end from the selection keypad.

It is possible that a customer could forget the item code number during the walk.

The situation gets more cumbersome if the customer has to purchase many items.

### SUMMARY OF THE INVENTION

Accordingly, it is the objective of this patent application to devise a vending machine that solves the problems listed above.

It is an accompanying objective of this patent application to devise a means to communicate with customer in real time, helping him during the selection process.

It is another accompanying objective of this present invention to devise a means to verify the age of customers through a real time video communication link.

These objectives are achieved by mounting the item-selector or keypad on a moveable frame that can ‘walk’ with the customer (‘Walking Item-Selector’).

A video camera with a remote communication means can be mounted on the ‘walking item-selector’ so that an attendant can view the immediate scene, namely the customer and the items that are currently viewed by the customer, and talk with the customer if necessary or when the customer asks questions. Such an extra service will make vending machine much more valuable and useful to customers. This sort of unique and valuable service becomes possible only when the customer and the item selector or keypad move together.

Various means and methods will be described.

### BRIEF DESCRIPTION OF DRAWINGS

FIG. 1 shows a schematic look of a large-capacity vending machine with an item-selector that can ‘walk’ with customer.

FIG. 2 shows the same with some useful options.

FIG. 3 indicates that the mobility of the item-selector allows sharing a same item-code number among a plurality of products on display.

FIG. 4 shows the same as shown in FIG. 3 except that lights indicating the item availability are added.

FIG. 5 shows in a highly schematic manner the ejection motion in a conventional vending machine.

FIG. 6 shows in a highly schematic manner the retrieval motion in one embodiment of the present invention.

FIG. 7 shows an example of the item-retrieval as depicted in FIG. 6.

### DETAILED DESCRIPTION

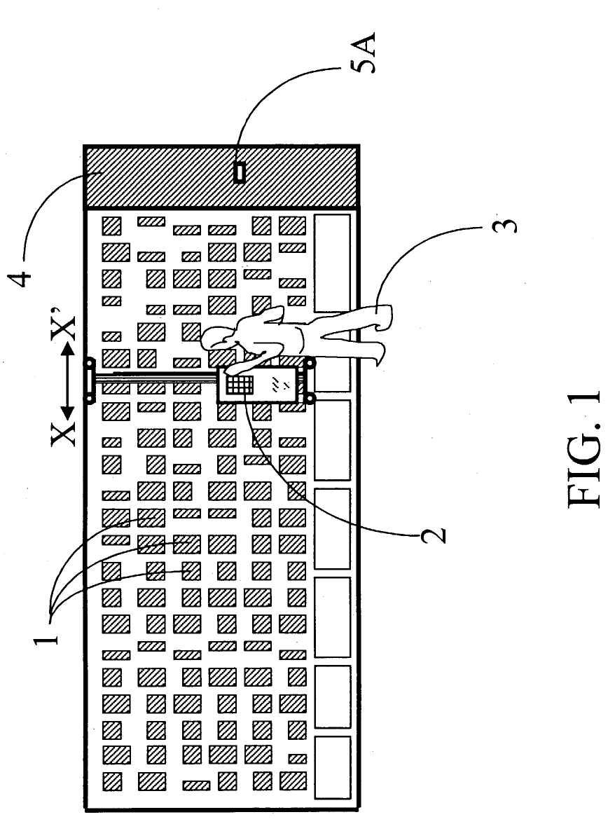

FIG. 1 shows, in a highly schematic manner, an overall view of a vending machine designed according to the present invention.

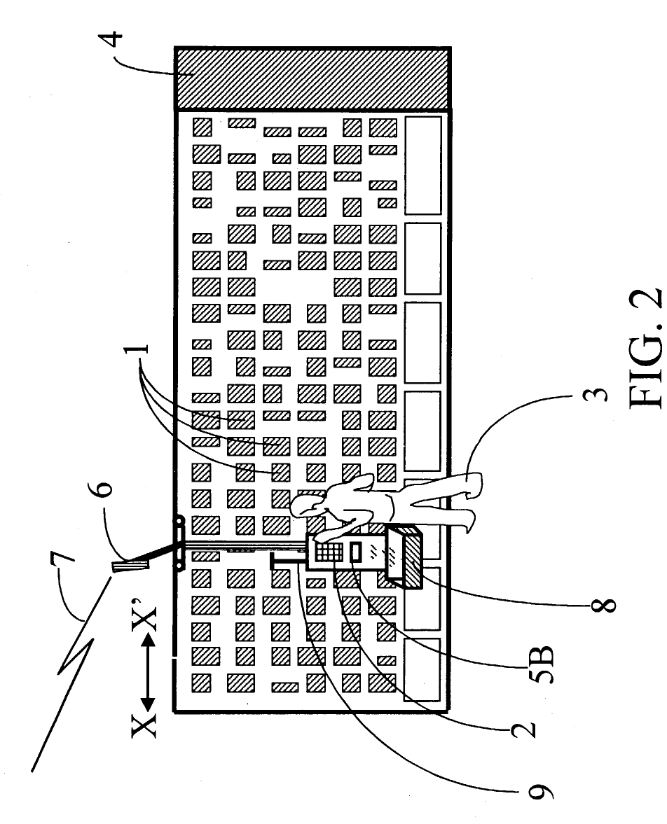

FIG. 2 depicts the same but with some optional functions attached.

The item-selection keypad of a vending machine is connected to the decision-making electronic hardware through a cable. It is located on one side of vending machine in the case of the conventional vending machines.

It is convenient for a customer if the item-selection keypad or the like, which we will call ‘item-selector’, can stay with the customer when the customer walks up and down during his decision-making period. It would be especially convenient when the size of the vending machine is relatively large, and/or when a customer is buying more than one item.

If the item-selector can ‘walk with customer’, it becomes possible to use a video/audio communication gear that moves with the moveable item-selector for providing additional services such as answering any questions posed by the customer while he is trying to figure out which item suits his need best.

This sort of personal service for vending machines may sound farfetched. But such a personal attention, if realized, will constitute a great paradigm shift on the vending retail business. And such a paradigm shift would become possible when the item-selector ‘walks with customer’. This patent application is trying to achieve this goal, as explained below in details.

FIG. 1 shows items 1 that are displayed, an item-selector 2, and a customer 3.

The item-selector 2 is designed to be moved up and down along the X-X′ axis following the desire of the customer 3.

The item-selector 2 may be dragged along manually by the customer 3.

Or, alternatively, the item-selector 2 may be moved by an automated or electromechanical means through a controller.

Even though it seems a simple matter to transform a stationary item-selector to a moveable one so that the item-selector 2 can walk up and down along the vending machine, it is rather complicated.

First, a multi-channel cable is connected between the item-selector or keypad and the hardware that controls and executes the vending process. This cable should be carried along with such an item-selector if the item-selector becomes moveable. This is a substantial electrical and mechanical task posing a challenging task.

Also, electrical power should be supplied to the moving hardware.

Then there is a coin changer and a bill acceptor into which coins and/or paper money are inserted by customers. These hardware pieces 5A usually are located on the one side 4 of vending machine as depicted in FIG. 1. These hardware pieces also should be somehow linked to the moveable item-selector 2 through the vending processing hardware.

However, it would be more convenient if the coin changer and bill acceptor, which we will term as ‘money-box’, walks together with the ‘walking item-selector’2. The money-box, or the combination of the coin changer with bill acceptor, is represented as 5B in FIG. 2.

However, this makes the money-box 5B substantially more vulnerable to vandalism because the money-box 5B cannot be fortified as heavily as in the conventional case (5A in FIG. 1). This is another challenge.

But the reward is substantial in terms of customer convenience. Actually customers could be confused if the money-box is located in one place (5A in FIG. 1) and the item-selector, being moveable, is located in other place.

In order to solve this security problem, a video camera 6 may be installed in such a way that it moves with the item-selector 2 as depicted in FIG. 2.

Taping what the video camera 6 sees is one security measure.

A better security measure is to transmitting the video signal 7 to a remote site where an attendant is monitoring the vending machine constantly. The attendant calls a security personnel or the police if the money-box 5B is vandalized. In this case, the money-box 5B should be only strong enough to withhold for about ten minutes, that is, until the police arrives.

Furthermore, by making the communication link 7 two-ways, the attendant can answer any questions posed by the customer 3 in real time. This is really new and bright feature that would make the vending machine not only convenient but also attractive (human touch!). This service would beat the service any conventional retail stores can provide. The camera 6 moves with the customer 3, and the remotely-located attendant sees what the customer 3 sees at a given moment. It is like a store assigning a store attendant to each customer 3 coming into the store.

It is also possible to sell controlled items such as cigarettes through such a novel vending machine. In order to establish this capability, the vending function is disabled for the vending section where cigarettes are sold. When a customer presents his driver license to the video camera 6 to prove that he is over a certain age dictated by the law, the remotely-located attendant turns on the vending function for the cigarettes.

Such a personal service and attention represents a great paradigm shift for the vending machine business.

A shopping basket 8 may be installed near the item-selector 2 for the convenience of customers. This basket 8 will help customers to understand that they are supposed to be with the moveable part 2 of the vending machine. Such a hint will be useful since the vending machine as presented by this patent application will be viewed as quite weird to customers new to this new vending machine design.

A wireless antenna 9 may be installed to link the moveable item-selector 2 to the rest of the stationary vending processing hardware. This will eliminate the need to drag a cable up and down as the item-selector 2 ‘walks’ with the customer 3.

There is still the need to connect the moveable item-selector 2 and any other hardware that move with the item-selector 2 to the electrical power source. The power may be supplied through a cable. In this case the cable should be long enough to cover the entire width of the vending machine.

Alternatively a ‘trolley’ can be used in which two wheels maintain electrical contacts with the two active electrodes of the power supply.

The electrical safety is an important factor in any of these power-supply arrangements.

The new teachings described in this invention disclosure will expand the realm of the vending machine business and bring in a new paradigm shift, benefiting the vending business operators and the customers alike, even though the changes require substantial engineering developmental effort.

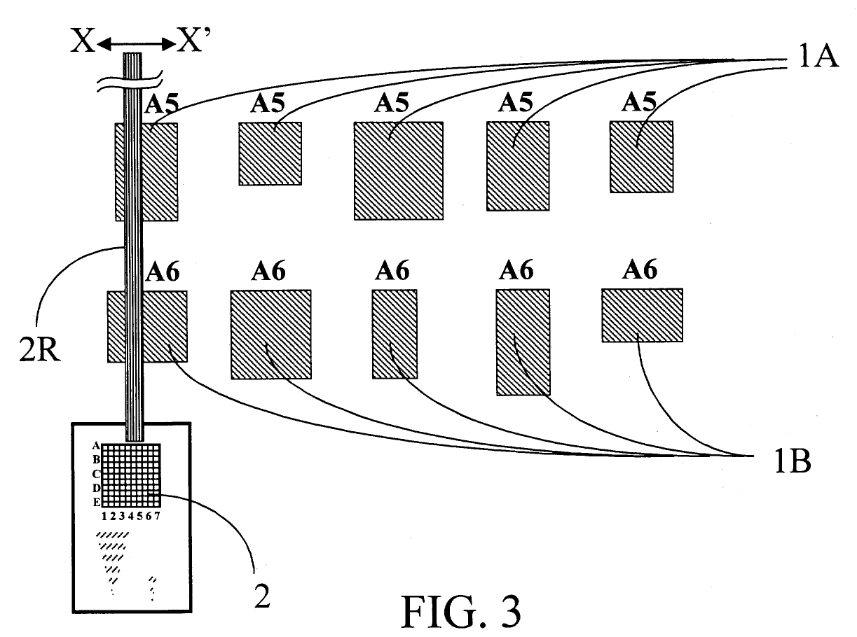

One additional feature made possible due to the mobility of the item-selector 2 is indicated in FIG. 3 in a grossly schematic manner.

In most of the vending machines, a keypad is provided, and a customer punches a particular item-code such as A1, A2, A3, . . . , B1, B2, B3 , etc. In general, different items should have different code numbers in one-to-one fashion. When the number of the items exceeds the normal number, which is 80, the number of the unique item-codes should increase accordingly. This drives up the manufacturing cost as the count of the mechanical hardware and the complexity of the control and processing electronics increase.

In the scheme presented in this patent application, one could use the position of the moveable item-selector 2 as a part of the item-selection mechanism. For example, the electrical power can be made remained off for all the vending area except for the immediate vicinity of the moveable item-selector 2. In this case, punching the keypad 2 activates vending process only on the items in that vicinity area of the item-selector 2.

In FIG. 3, there are many items 1A with a same item-code A5. There will be no ambiguity though since, when a customer selects A5, only the item A5 in the first column is selected in FIG. 3 because the item-selector 2 is parked on that column at this particular moment.

A rod or the like 2R may be used to indicate which items are eligible for selection.

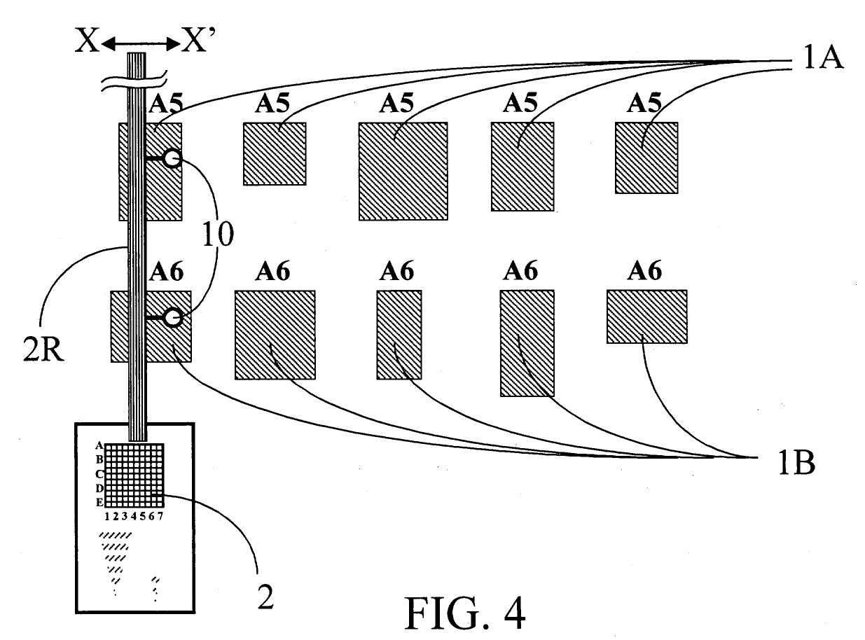

Indication lights can be used to inform the customer 2 which items are available for vending process at a particular moment. FIG. 4 shows the same as shown in FIG. 3, except that such indication lights 10 are added. Only the items located at the positions of the lights 10 are connected to the electrical power or/and to the vending process hardware. The lights 10 may be turned on, or alternatively turned to a different color (from red to green) when the lights are lined up with certain items properly for vending. At this moment, all other items remain disconnected from the vending process.

The fact that customers should choose only among the items coinciding with the indication lights 10 should be posted on the vending machine. This would cause a substantial confusion and even frustration because this is very unusual and unfamiliar restriction unknown to the current vending machine business.

The number of selection at a given moment is only a few or several while the total number of items could be a few thousands, and accordingly the manufacturing cost of the vending machine could be reduced substantially due to the simplified vending processing hardware. Lowering the manufacturing cost of vending machines is crucial in pushing the envelope of the vending services in retail market.

Since the customer 3 ‘walks with the item-selector 2’, the limitation, namely that only the items in the vicinity of the item-selector 2 can be selected by the customer 3, would not cause any inconvenience or restriction to the customer 3.

One way to implement the feature described above, namely that only the items in the vicinity of the item-selector 2 can be selected by the customer 3, is to install ‘active components’ such as motors, electromagnets, or the likes on the side of the item-selector 2.

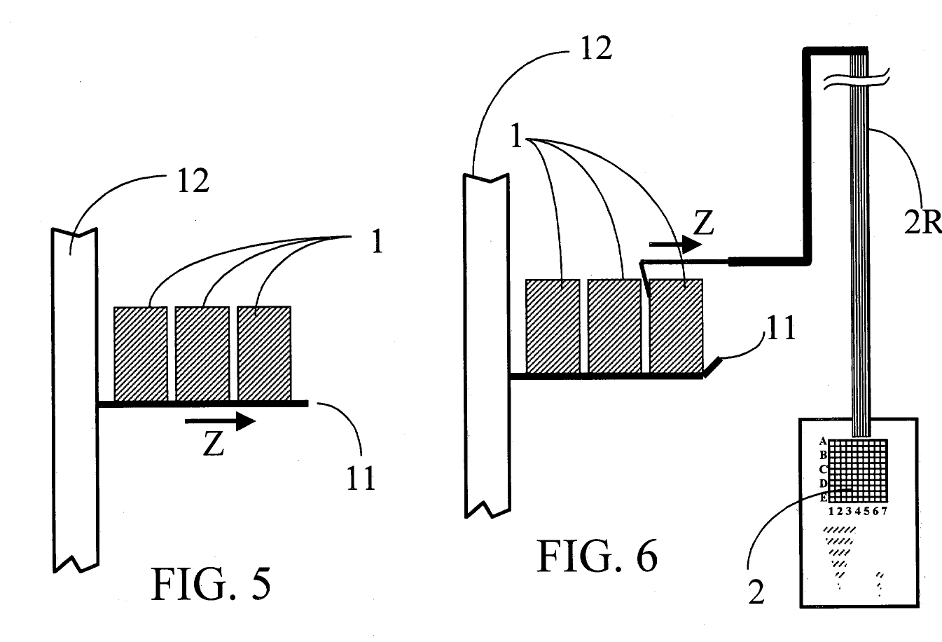

FIG. 5 shows items 1 on a shelf 11. The shelf 11 is secured on a frame 12. In the conventional vending machines, ‘active components’, such as motors, installed on the side of shelf 11 eject the item 1 away from the shelf 11 as indicated by the arrow ‘Z’.

In the present invention, the ‘active components’ may be installed on the side of the moving frame 2R. And, as depicted in FIG. 6 in a highly schematic fashion, the ‘active components’ retrieve an item 1 from the shelf 11, as symbolized by the arrow ‘Z’. If the ‘active components’ provided on the side of the item-retriever 2 are used to retrieve items from the shelves, the number of items 1 to be differentiated (to be chosen from) in the vending processing is only a few or several at a given moment, even though the total number of products being offered could reach a few hundreds or even thousands.

There will be a numerous ways and embodiment for retrieving items as depicted in FIG. 6. The exact method and embodiment are immaterial in the present patent application.

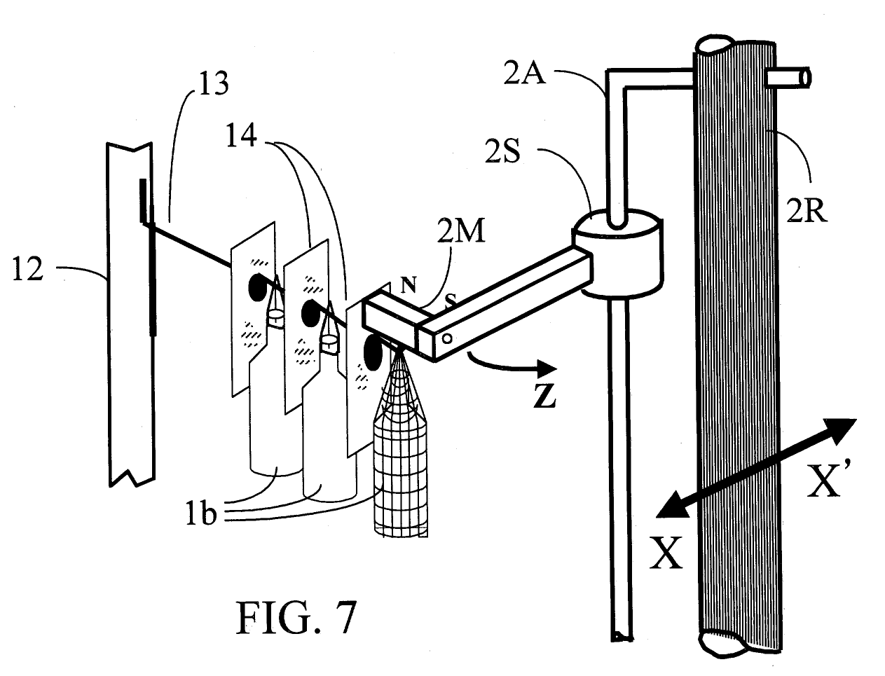

One embodiment was presented in a previous patent application Ser. No.10/299,502, titled, “Means of Item-Retrieving from a Display Hook, and Methods of Using it”, and is depicted in FIG. 7. A frame 12 holds a slanted hook 13. Items 1 are hung on the hook 13. Between two neighboring items 1 is inserted a metal piece 14 that sticks to a magnet upon physical contact. An electromagnet 2M swings out in the ‘Z’ direction to pull the first metal piece 14 in contact. When the first metal piece 14 is removed from the hook 13 by the magnet 2M, the item 14 that is located in front of the metal piece 14 is also removed from the hook. An active component 2S, a motor or the like, is installed on a frame 2A, which is a part of the item-selector frame 2R (REF: FIG. 4).

Obviously many modifications and variations of the present invention are possible in light of the above teachings. It is therefore to be understood that, within the scope of the appended claims, the invention may be practiced otherwise than as specifically described.

1. A self-service merchandise vending machine comprising a plurality of vending items (1) displayed for selection, and an item-selector (2); wherein the item-selector (2) is moveable across the vending items (1) so that the item-selector (2) can ‘walk’ with customer (3) while the customer (3) walks up and down in his effort to select an item among the vending items (1).

2. The invention according to claim 1, wherein the item-selector (2) is designed to be moved manually by the customer (3).

3. The invention according to claim 1, wherein the item-selector (2) is designed to be moved by a machine power.

4. The invention according to claim 1, wherein a money-box (5B) is located near the item-selector (2) and moves together with the item-selector (2).

5. The invention according to claim 1, wherein a shopping basket or the like (8) is located near the item-selector (2) and moves together with the item-selector (2).

6. The invention according to claim 1, wherein a wireless communication means (9) is located near the item-selector (2) so as to relay the signals between the item-selector (2) and other vending processing hardware.

7. The invention according to claim 1, wherein a video camera (6) is located near the item-selector (2) and moves together with the item-selector (2).

8. The invention according to claim 7, wherein the video camera (6) is linked to a remote site by communication means for monitoring of the vending machine.

9. The invention according to claim 8, wherein the communication means is capable of two-way communication so that the customer (3) and an attendant in the remote site can communicate to each other.

10. The invention according to claim 9, wherein the two-way communication means is used to determine whether the customer (3) is eligible to buy a controlled item such as cigarettes.

11. The invention according to claim I, wherein only the items (1A) in the vicinity of the moveable item-selector (2) are available for sale through the vending process at a given moment.

12. The invention according to claim 11, wherein a plurality of items (1A) share a same item-code number (A5) when they do not belong to a same vicinity of the moveable item-selector (2).

13. The invention according to claim 11, wherein indication lights (10) are used to indicate the items that are eligible for vending at a given moment.

14. The invention according to claim 1, wherein ‘active components’ such as motor, electromagnet, or the likes for retrieving items for the vending process are provided on the side of the item-selector 2.

15. A method of using a vending machine in which a customer (3) can walk with a moveable item-selector (2). during the item-selection process so that the customer (3) does not have to walk back and forth between the displayed items (1) and the item-selector (2).

16. A method according to claim 15, in which a video camera (6) moves together with the item-selector (2) to view the immediate vicinity of the item-selector (2) for monitoring purpose.

17. A method according to claim 16, in which the video camera (6) is monitored by an attendant stationed in a remote location through a communication link.

18. A method according to claim 17, in which the remote communication capability is used to determine the eligibility of the customer (3) who wants to buy a controlled item such as cigarettes.

19. A method according to claim 15, in which the customer (3) is allowed to buy only those items in the vicinity of the item-selector (2) at a given moment.
